(19) United States
(12) Patent Application Publication
(10) Pub. No.: US 2024/0413481 A1
(43) Pub. Date: Dec. 12, 2024

(54) CELL VENTING CHANNEL ARRANGEMENT AND METHOD FOR DISCHARGING GASES FROM A BATTERY

(71) Applicant: AUDI AG, Ingolstadt (DE)

(72) Inventors: Carsten LORENZ, Reichertshofen (DE); Paul SCHNEIDER, Großmehring (DE)

(73) Assignee: AUDI AG, Ingolstadt (DE)

(21) Appl. No.: 18/699,721

(22) PCT Filed: Oct. 11, 2022
(86) PCT No.: PCT/EP2022/078175

§ 371 Date: Apr. 9, 2024

(30) Foreign Application Priority Data
Oct. 25, 2021 (DE) 10 2021 127 622.5

(51) Int. Cl. H01M 50/383; B60R 16/033; H01M 10/613; H01M 10/625; H01M 10/63; H01M 10/6564; H01M 50/358

(52) U.S. Cl. CPC H01M 50/383; H01M 10/613; H01M 10/625; H01M 10/63; H01M 10/6564; H01M 50/358; B60R 16/033; H01M 2220/20

(57) ABSTRACT

The invention relates to a cell degassing channel arrangement with a cell degassing channel for discharging gases from a battery which has at least one battery cell, wherein the cell degassing channel has at least one inlet opening, and has an outlet opening, and is designed such that a gas emerging from the at least one battery cell can be introduced through the at least one inlet opening into the cell degassing channel, can be guided through the channel to the outlet opening and can be discharged from the outlet opening. In particular, the cell degassing channel has at least one component for gas cooling that is different from a cooling device for cooling the battery.

### FIELD

The invention relates to a cell degassing channel arrangement with a cell degassing channel for discharging gases from a battery which has at least one battery cell, wherein the cell degassing channel has at least one at least releasable inlet opening, at least one at least releasable outlet opening, and is designed such that a gas exiting the at least one battery cell can be introduced into the cell degassing channel through the at least one inlet opening, can be guided through the channel to the at least one outlet opening, and can be discharged from the at least one outlet opening. Furthermore, the invention also relates to a method for discharging gases from a battery.

### BACKGROUND

In the event of a thermal runaway of a cell, namely a thermal propagation of a cell, hot, ignitable gases are produced. These can self-ignite when exiting the battery system. This is due, on the one hand, to the high gas temperature and, on the other hand, to the hot particles contained in the gas. It would therefore be desirable if the exit temperature of this harmful gas and of the particles contained therein could be reduced to such an extent that the escape of a flame from the battery system or spontaneous ignition of the gas outside the battery after its escape can be ruled out.

DE 10 2012 214 984 A1 describes an exhaust gas guide device with a main guide piece, which is suitable for use in an exhaust system of a motor vehicle with an internal combustion engine and battery. The main guide piece comprises a jacket, an enclosed cavity, an inlet opening and an outlet opening arranged from the inlet opening in a main flow direction. The exhaust gas guide device also has a secondary piece which comprises a further jacket, a further enclosed cavity, an inlet opening and an outlet opening, wherein the outlet opening of the secondary guide piece is connected to a further inlet opening of the main guide piece. In this way, the degassing opening of the battery pack can be connected to the vehicle's exhaust system and battery outgassing can get into the exhaust system and ultimately out of the vehicle into the outside environment.

Unfortunately, supplying a harmful gas to the exhaust system of an internal combustion engine is only possible if such an internal combustion engine is present in the vehicle. Otherwise, the design of such an additional exhaust system without an internal combustion engine requires enormous additional effort.

Furthermore, DE 10 2018 220 992 A1 describes a safety device for an electrochemical energy storage that has a bursting valve and a cooling device. Hot gases escaping through the bursting valve can thus be cooled down rapidly. For cooling, a cooling plate can be provided, which is also designed as a cooling plate of the battery pack, so that the escaping gas can be guided along the underbody of the vehicle or along the cooling plate of the battery pack.

When guiding the harmful gas along the cooling plate of the battery pack, the major disadvantage is that the cooling effect is enormously reduced, since in this case the cooling plate is also in thermal contact with the thermal runaway battery cell and thus absorbs an enormous amount of heat from it. At the same time, this also limits the spatial design options for gas discharge.

### SUMMARY

The object of the present invention is therefore to provide a cell degassing channel arrangement and a method which make it possible to increase the safety in connection with the discharging of gases from a battery in the event of a thermal runaway of at least one battery cell in the most effective manner possible.

A cell degassing channel arrangement according to the invention has a cell degassing channel for discharging gases from a battery which has at least one battery cell, wherein the cell degassing channel has at least one at least releasable inlet opening, at least one at least releasable outlet opening, and is designed such that a gas exiting the at least one battery cell can be introduced into the cell degassing channel through the at least one inlet opening, can be guided therethrough to the at least one outlet opening, and can be discharged from the at least one outlet opening. The cell degassing channel has at least one component for gas cooling that is different from a cooling device for cooling the battery and through which a coolant can flow, which component is arranged in such a way that, in the event that a gas exiting the at least one battery cell is introduced into the cell degassing channel, the component is at least partially flowed over by the gas, while the gas is flowing through the cell degassing channel.

As a result, it can advantageously be achieved on the one hand that the harmful gas produced in the event of a thermal runaway of a cell is specifically directed out of the battery via a suitable system, namely the cell degassing channel, and at the same time the gas flows over or even flows through a structure through which, for example, cooling water flows as a coolant, namely the component through which coolant can flow. As a result, a lot of heat energy can be transferred from the gas as it flows through the cell degassing channel to this at least one component through which the coolant can flow. By allowing the coolant to flow through the component, it is advantageously possible to transport the heat away, in particular to other regions of the battery and/or the motor vehicle. This means that the thermal capacity of other battery and vehicle components can be effectively used to absorb the energy. This makes such cooling much more efficient than, for example, a purely passive cooling component, that is, a component through which coolant cannot flow. The fact that this component through which the coolant can flow is also one that is not used to cool the battery also has the great advantage that significantly more efficient cooling of the gas flow is possible and significantly better thermal decoupling from the battery can be provided. Nevertheless, the component can, for example, be connected to the same coolant circuit as, for example, a cooling device for cooling the battery. The fact that the component is a component different from a cooling device for cooling the battery should be understood to mean that battery cells, for example, are arranged on this component in a non-directly contacting manner or are connected thereto via a heat-conducting element. Gas cooling and battery cooling can, for example, also be implemented via separate partial circuits. The gas cooling via the component can then advantageously be connected only when necessary, that is, in the event of degassing of a battery cell. In addition, this allows for much more geometrically flexible design options for the gas cooling component itself. It is preferred that this component does not represent, or at least not exclusively, the wall of the cell degassing channel, although wall cooling would in principle also be conceivable, but rather that this component for gas cooling is integrated as a structural element in the inner space, i.e. in the interior, of the cell degassing channel, so that this component is directly flowed through by the gas flow flowing through the cell degassing channel. This advantageously also allows the usable cooling surface to be maximized. This will be described in more detail later. Overall, this allows a gas emerging from a thermal runaway cell to be cooled before it exits from the at least one outlet opening, thereby significantly reducing the probability of the gas igniting upon exit. At the same time, this can be provided in a particularly effective manner, since hardly any additional installation space is required, since this is made possible just by providing, for example, already existing structures with cooling channels through which a coolant can flow and by connecting them to the cooling circuit, and also with an extremely efficient cooling since the component is not simultaneously used to cool the battery itself.

The battery can preferably be, for example, a high-voltage battery. In particular, the battery can have not just one battery cell, but preferably multiple battery cells. The battery can optionally comprise multiple battery modules, each of which comprises multiple battery cells. The battery cells or battery modules can be arranged in an overall battery housing of the battery. A respective battery cell or generally the at least one battery cell has a releasable cell degassing opening. Such a cell degassing opening can be provided, for example, in the form of a bursting membrane that ruptures when the internal pressure within the cell exceeds a predetermined value. This allows controlled outgassing of the cell in the event of thermal runaway of the cell. The properties and design options described for the at least one battery cell apply in the same way to other battery cells if the battery comprises multiple battery cells. The releasable cell degassing opening can therefore be coupled to the cell degassing channel or be coupled in the intended installation position of the cell degassing arrangement, so that the gas emerging from the battery cell can be introduced into the cell degassing channel through the at least one releasable inlet opening of the cell degassing channel. For example, the cell degassing channel can also have multiple inlet openings if the battery comprises multiple battery cells, wherein a respective inlet opening is associated with exactly one battery cell.

An at least releasable inlet opening should be understood to mean an opening that is either permanently present, that is, permanently released, for example a hole, or that is only released under certain conditions and is normally closed, such as in the case of a valve or a bursting membrane. Such a condition can be, for example, exceeding a certain temperature or pressure. For example, these inlet openings can also be designed as bursting membranes, which are only released in case of degassing of the corresponding battery cell. The same applies to the outlet opening. This can also be designed as a permanent opening, or can only be released when, for example, a pressure threshold is exceeded. For example, the at least one outlet opening can be designed as a pressure valve. Here too, it is conceivable that the cell degassing channel also has multiple such outlet openings, depending on the design. The cell degassing channel can further comprise a channel wall which separates an interior of the cell degassing channel from an outside environment of the cell degassing channel. This can prevent the gases emerging from a battery cell from randomly spreading in the battery housing.

The component through which a coolant can flow can now advantageously achieve cooling of the gas as it flows through the cell degassing channel, whereby the probability of flame formation after exiting the battery system is enormously reduced or can even be prevented. It represents a further very advantageous embodiment of the invention that the cell degassing channel arrangement is designed in such a way that the coolant flows through the component when a gas flows through the cell degassing channel. In this way, the heat transferred by the gas to the component can be efficiently removed. This means that significantly more heat energy can be absorbed by the component itself, which energy can be efficiently distributed to other battery components or cooling circuit components and/or vehicle components by circulating the coolant flowing through the component, depending on which such components are connected to the cooling circuit. This also enables, for example, semi-active cooling, according to which, for example, only a pump for pumping or circulating the coolant in the cooling circuit is activated, while the coolant itself is not actively cooled by a cooling device, for example a cooling circuit with an air conditioning compressor or by a radiator fan or similar. This has the advantages explained below, that, for example, no high-voltage on-board power supply is required to circulate the coolant in the cooling circuit and to flow the coolant through the component for gas cooling.

In a further advantageous embodiment of the invention, the cell degassing channel arrangement has a pumping device, in particular the coolant pump already mentioned above, which is designed to pump a coolant through the component, and a control device for controlling the pumping device, wherein the cell degassing channel arrangement is designed in such a way that the control device activates the pumping device at the latest when a fault detection signal is received by the control device, which relates to a gas leakage of a gas from the at least one battery cell. The fault detection signal can be provided, for example, by a detection device for battery cell monitoring. If thus a gas escaping from a cell, or a thermal runaway of a cell or another fault condition is detected by the detection device, which suggests that gas is or will soon be escaping from the cell, the control device can advantageously control the pumping device in order to activate it or, if it is already active for any reason, to continue operating it. For example, it can be provided that the pumping device is designed not only to pump the coolant through the component, but generally through a cooling circuit to which other cooling devices are also connected. This cooling circuit can, for example, be formed into individual partial circuits, for example using valves, wherein the component for gas cooling can be located in its own partial circuit of this type. In this case, it is conceivable, for example, that in the fault condition described, the pump is already active, for example to pump coolant through another cooling device, for example to cool the battery down. In this case, the control device can also be designed to release a flow through the partial circuit in which the component for gas cooling is arranged, for example by opening a valve device, when the fault detection signal is received. In any case, this makes it possible for the coolant to flow through the component in the event that gas emerges from at least one battery cell.

Both the pumping device and the control device for controlling the pumping device and for optionally controlling any valve devices that are provided in the cooling circuit can be supplied with a low-voltage from a low-voltage on-board electrical system as a supply voltage. This means that these components can advantageously be operated independently of the functionality of a high-voltage on-board electrical system, which is usually powered by the battery, which, as described, is preferably designed as a high-voltage battery. Operation of the control device and the pumping device can thus be ensured even in the event of a battery failure. This enables the semi-active operation already defined above and thus semi-active cooling.

Therefore, it represents a further very advantageous embodiment of the invention if the cell degassing channel arrangement is designed in such a way that coolant flowing through the component is not actively cooled. Accordingly, the coolant flows through the component, while other electrical components for cooling the coolant, such as an electric air conditioning compressor in a coolant circuit or a radiator fan, do not have to be active. The energy required for the flow through the component can thereby be reduced to a minimum and, in particular, can be provided in sufficient quantity by a low-voltage on-board electrical system of the motor vehicle. This is particularly advantageous in the described defect case of outgassing of at least one battery cell. This means that operation is guaranteed even if the high-voltage on-board electrical system and the battery, especially the high-voltage battery, are completely inoperable.

Nevertheless, according to a further embodiment of the invention, it is also conceivable that the cell degassing channel arrangement is designed in such a way that the coolant flowing through the component is actively cooled. The cooling does not necessarily have to take place via a refrigerant circuit, which is difficult, due to the fault of the battery, in terms of providing a suitable supply voltage. Nevertheless, cooling using a fan, such as a radiator fan, is still possible. Such a fan can also be operated with low voltage, for example. This can further increase the heat dissipation efficiency.

In a further advantageous embodiment of the invention, the cell degassing channel has a channel wall which separates an interior of the cell degassing channel from an environment, wherein a gas guiding structure different from the channel wall is arranged in the interior of the cell degassing channel, which structure is designed to influence a flow behavior of a gas flow flowing through the cell degassing channel, wherein the gas guiding structure comprises or represents the component for gas cooling. This has the great advantage that such a gas guiding structure integrated into the interior of the cell degassing channel can provide a significantly larger surface area that can be flowed through, which can therefore be used to cool the gas flowing through, with respect to the case in which the channel wall or only the channel wall is used for cooling. in that it has or represents part of the component for gas cooling. In particular, the cell degassing channel arrangement can also include multiple components for gas cooling through which a coolant can flow. These components can be designed as described for the at least one component. Overall, these components form a cooling device for cooling the gas flow. As already described, it is particularly advantageous that the gas guiding structure comprises or represents such a component for gas cooling. As a result, this gas guiding structure, which is arranged inside the cell degassing channel, is therefore located directly in the flow path of the gas which flows through the cell degassing channel from the at least one inlet opening to the at least one outlet opening. The gas guiding structure can also take on various forms and, in addition to cooling the gas flowing through it, can also take on other functions, for example subdividing the gas flow into multiple partial flows, redirecting the gas flow or partial flows and/or braking the gas flow and promoting particle separation, as will now be explained in more detail below.

According to an advantageous embodiment of the invention, the gas guiding structure is designed with numerous fins. In other words, the gas guiding structure has numerous fins, which preferably divide the interior of the cell degassing channel at least in some regions into numerous individual flow channels, wherein each of the flow channels adjoins a channel wall provided by the component, which delimits the respective flow channel, and/or wherein the fins are arranged on the component. A subdivision into numerous individual flow channels can take place, for example, in a direction perpendicular to the main flow direction or in two directions perpendicular to the main flow direction. In other words, for example, the main flow direction can be directed in a longitudinal direction of the cell degassing channel and define a first direction, wherein a longitudinal direction of the cell degassing channel is aligned perpendicular to a height and width of the cell degassing channel, at least locally, since the cell degassing channel does not necessarily have to run in a straight line. Then, for example, the interior of the cell degassing channel can be divided into numerous small flow channels both in the direction of its width and in the direction of its height by providing these numerous fins. The fins can be provided as sheets, for example. In addition, the component can have multiple plates aligned parallel to one another and through which the coolant can flow, which plates are spaced apart from one another in a second direction perpendicular to the first. This space between the plates in the second direction can be divided into numerous flow channels by the numerous fins in a third direction perpendicular to the first and second directions. The fins can be provided, for example, in the form of a corrugated sheet metal, which is arranged between two such plates through which the coolant can flow. This means that each flow channel also adjoins a plate and that the fins, which are not flowed through by the coolant, are also cooled by their connection to the plates through which the coolant flows. The gas guiding structure can, for example, be designed similar to a conventional motor vehicle liquid cooler in the region of the radiator grille.

In a further very advantageous embodiment of the invention, the gas guiding structure does not run in a straight line in a main direction that corresponds to a first direction and is designed such that a gas flow flowing through the cell degassing channel undergoes multiple changes of direction through the gas guiding structure with respect to a second direction perpendicular to the first during its course in the main direction.

The first direction, that is, the main direction, corresponds, for example, to the longitudinal direction of the cell degassing channel defined above. If the gas flowing through the cell degassing channel is deflected multiple times perpendicular to this main direction, this leads, for example, to a wave-shaped or zigzag-shaped course of the gas flow in the main direction. This can be made possible in a simple manner, for example, by a gas guiding structure that runs in a wave-like or zigzag-manner in the first direction. For this purpose, the gas guiding structure can in turn be designed in such a way that it divides the interior of the cell degassing channel into numerous flow channels, at least in some regions. The division here preferably takes place in only one direction, for example in the defined second or third direction. The gas guiding structure can be provided, for example, by numerous sheets that extend in a wavy or zigzag shape in the main direction, which sheets are at a distance from one another in the second direction, and which are each designed so that a coolant can flow through them. The gas guiding structure provides the walls of the respective flow channels, wherein the walls of the respective flow channels are consequently designed as components for gas cooling through which the coolant can flow. The multiple deflections in turn promote the separation of particles contained in the gas or in the gas-particle mixture. The more particles are separated, the lower the risk of the gas spontaneously igniting when it exits the battery system. The multiple deflection of the gas flow also leads to a braking of the gas flow, which in turn reduces its temperature. The energy released by the gas flow is in turn delivered to the walls of the respective flow channels and can be efficiently removed by the coolant flowing through them.

Alternatively or additionally, the gas guiding structure can be designed as at least one perforated plate arranged in the inner space, or interior, at an angle to the main direction, in particular arranged perpendicular to the main direction, which perforated plate has multiple holes which can at least partially be passed through by a gas flow flowing in the cell degassing channel. Optionally, multiple such perforated plates can be arranged one behind the other in the main direction. The hole sizes can decrease from perforated plate to perforated plate in the main direction. This promotes increasing particle separation as they flow through the holes of the respective perforated plates. In addition, the holes of different perforated plates arranged next to one another in the main direction are offset from one another in such a way that they are not aligned with one another in the main direction. This prevents a straight linear flow through the perforated plates. These perforated plates can in turn be designed so that a coolant can flow through them. The gas hits the perforated plates or flows through their holes and is at the same time cooled particularly efficiently. When hitting the perforated plates, the gas is additionally slowed down and particles are deposited on the perforated plates. The holes can, for example, have dimensions from a maximum of 1 cm in diameter to a diameter of just a few millimeters, for example 1 mm.

In addition, there are numerous other possibilities as to how such a gas guiding structure, which is simultaneously provided as a component for gas cooling through which a coolant can flow, can be designed. For example, the gas control structure can also divide the cell degassing channel into multiple individual flow channels running in the first direction, for example in the second direction perpendicular to the main direction, wherein two flow channels are respectively separated from each other by a free region in the second direction. The inlet openings can open into these respective free regions between the flow channels, while the respective outlet openings, of which, for example, one can be provided per flow channel, are arranged within a respective flow channel.

The walls of the flow channels can be designed to be gas-permeable at least in some regions, for example in the form of nets or with holes. The gas permeability of the walls of the flow channels can vary in at least one direction, for example in the main direction. For example, it can also vary depending on the distance from the corresponding outlet opening arranged in the respective flow channel, for example in that the gas permeability increases with increasing distance from the outlet opening. Such a design is particularly advantageous if the cell degassing channel is designed, for example, with a chamber comprising this gas guiding structure, which is arranged, for example, directly above or preferably below the battery with respect to the third direction, in particular in an intermediate space between the battery and an underride guard of the motor vehicle, which can provide a chamber wall. This gas guiding structure described then advantageously allows a particularly uniform distribution of the gas within the chamber. The walls of the individual flow channels can be designed so that a coolant can flow through them and accordingly represent the component for gas cooling. Further deflection structures, for example curved sheets, webs or the like, can also be arranged within the flow channels in order to achieve gas guiding, deflection, braking and the like. These can, for example, extend in a wave-shaped manner in the main direction or be designed as webs that are separated from one another and extend in the main direction, or as webs or curved webs that run at an angle to the main direction. Such gas guiding structures can in turn be designed so that a coolant can flow through them.

In a further advantageous embodiment of the invention, the cell degassing channel arrangement comprises the battery with the at least one battery cell. The battery can be designed as already described, for example as a high-voltage battery with numerous battery cells. In addition, the battery cells can be designed as lithium-ion cells, for example.

A motor vehicle having a cell degassing channel arrangement according to the invention or one of its embodiments should also be regarded as included in the invention. The battery is in particular arranged in an underbody region of the motor vehicle. In principle, however, any other position is also conceivable. In addition, one cell degassing channel arrangement or at least one cell degassing channel can be provided for each battery module, module group or even for the entire battery. For example, the gas guiding structures described above can also be arranged in a chamber of the cell degassing channel, wherein multiple separate supply channels of the cell degassing channel lead to this chamber. The individual feed channels can, for example, be associated with a respective battery module of the battery. However, the cell degassing channel itself can also be designed as such a chamber and can be arranged, for example, directly below the battery, for example between an underride guard of the motor vehicle and an underside of the battery housing The gas can then be introduced, for example, directly from the individual degassing openings of the cells vertically downwards into this cell degassing channel.

The motor vehicle according to the invention is preferably designed as an automobile, in particular as a passenger car or truck, or as a passenger bus or motorcycle.

Furthermore, the invention also relates to a method for discharging gases from a battery that has at least one battery cell via a cell degassing channel that has at least one at least releasable inlet opening and at least one at least releasable outlet opening. In this case, a gas emerging from the at least one battery cell is at least partially introduced into the cell degassing channel through the at least one inlet opening, passed through this to the at least one outlet opening and discharged from the at least one outlet opening. The cell degassing channel additionally has at least one component for gas cooling that is different from a cooling device for cooling the battery and through which a coolant can flow, which component, in the event that a gas exiting the at least one battery cell is introduced into the cell degassing channel, is flowed through by the coolant and is at least partially flowed over by the gas, while it is flowing through the cell degassing channel.

The advantages mentioned for the cell degassing channel arrangement according to the invention and its embodiments also apply similarly to the method according to the invention.

The invention also includes developments of the method according to the invention, which have features as have already been described in conjunction with the developments of the cell degassing channel arrangement according to the invention. For this reason, the corresponding developments of the method according to the invention are not described again here.

The invention also comprises the combinations of the features of the described embodiments. The invention therefore also comprises implementations that respectively have a combination of the features of several of the described embodiments, provided that the embodiments have not been described as mutually exclusive.

### BRIEF DESCRIPTION OF THE FIGURES

Exemplary embodiments of the invention are described hereinafter. In particular:

FIG. 1 shows a schematic representation of a cell degassing channel arrangement with a cell degassing channel according to an exemplary embodiment of the invention;

FIG. 2 shows a schematic representation of a cell degassing channel arrangement with a cell degassing channel according to a further exemplary embodiment of the invention;

FIG. 3 shows a schematic representation of a perforated plate as part of a gas guiding structure of the cell degassing channel from FIG. 2 according to an exemplary embodiment of the invention; and

FIG. 4 shows a schematic representation of a cell degassing channel arrangement with a cell degassing channel having an integrated finned cooling according to an exemplary embodiment of the invention;

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, the same reference numerals respectively designate elements that have the same function.

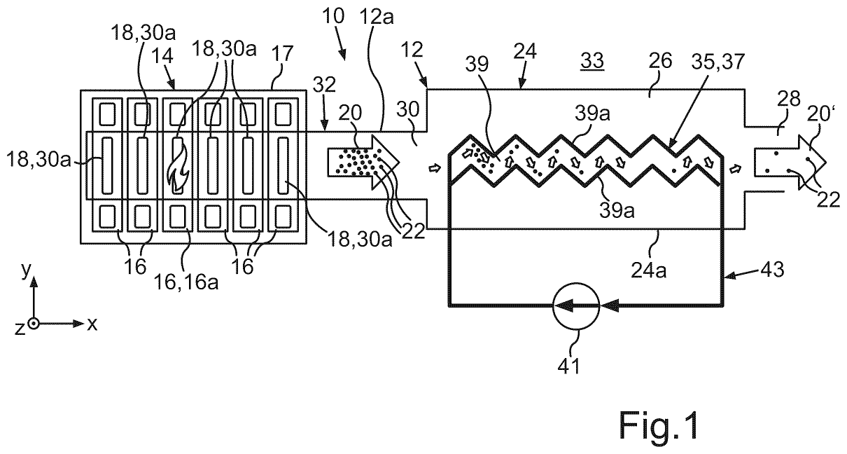

FIG. 1 shows a schematic representation of a cell degassing channel arrangement 10 having a cell degassing channel 12 according to an exemplary embodiment of the invention. In addition to the cell degassing channel arrangement 12 in this example, the cell degassing channel arrangement 10 also has a battery 14 which comprises at least one battery cell 16. In the present example, the battery 14 comprises multiple battery cells 16. These can be arranged in a battery housing 17. A respective battery cell 16 has a releasable inlet opening 18. Such a releasable inlet opening 18 can be provided, for example, by an opening in the cell housing of the cells 16, which opening is closed by a bursting membrane during normal operation. In the event of a defect in a battery cell 16, as in this example of the battery cell 16a, this opening 18 can open due to the overpressure created in the cell 16, whereby the cell 16 can outgas in a controlled manner. In order to discharge the gas 20, which actually represents a gas-particle mixture 20 and, in addition to gas molecules, also hot and in particular electrically conductive particles 22, in a controlled manner from the battery 14 and in particular from the motor vehicle in which the cell degassing channel arrangement 10 is arranged, the cell degassing channel arrangement also has the already mentioned cell degassing channel 12. This can, for example, in turn comprise a chamber 24, which can be designed, for example, as a widening of the cell degassing channel 12 in one or in two spatial directions. The cell degassing channel 12, in particular its chamber 24, has an inner space 26 or an interior 26, into which the gas 20 emerging from the cell 16a can be introduced and through which this introduced gas 20 can be guided to an outlet opening 28 of the cell degassing channel 12. The gas 20 can be introduced into the chamber 24 through a corresponding inlet opening 30. To introduce the gas emerging from the battery cell 16a into the cell degassing channel 12, the cell degassing channel 12 can also have an additional inlet opening 30a in a region different from the chamber 24, which inlet opening corresponds to the degassing opening 18 of the battery cell 16a. In particular, the cell degassing channel 12, which runs in the z-direction shown above the battery cells 16, can have an associated inlet opening 30a for a respective battery cell 16, which is coupled to the respective degassing opening 18 of the respective cell 16.

The cells 16 are illustratively designed as prismatic battery cells and are shown in a top view from above of the cell sides with the cell poles. These can basically be designed in any different form, for example as round cells or pouch cells.

The inlet openings 30a in the cell degassing channel 12 associated with respective battery cells 16 in this example are arranged in a channel portion 32 which is fluidly connected to the chamber 24. However, it would also be conceivable to dispense with this additional channel portion 32 and to couple the chamber 24 directly to the battery 14, so that the gas 20 emerging from the cells 16 can be directly introduced into the chamber 24 through corresponding inlet openings 30a, which can then be correspondingly provided in the chamber wall 24a. For example, the chamber 24 may be located directly above or below the battery 14 with respect to the z-direction shown. The chamber wall 24a is also part of a channel wall 12a of the cell degassing channel 12, which separates the interior 26 of the cell degassing channel 12 from an environment 33.

The gas 20 introduced into the cell degassing channel 12 in the present example is very hot and, as already mentioned, contains numerous particles 22. For reasons of clarity, only some of these particles 22 are provided with a reference number. The cell degassing channel 12 can now advantageously provide a significant cooling of this gas 20 entering the cell degassing channel 12, as will now be explained in more detail below. For this purpose, a component 35 through which a coolant, for example water or a water-glycol mixture, can flow is arranged in the interior 26 of the cell degassing channel 12, in particular within the chamber 24. This component 35 is simultaneously provided by a gas guiding structure 37. In this example, this gas guiding structure 37 is designed in such a way that the gas 20 flowing through the cell degassing channel 12 can flow through it and thereby it deflects the gas flow multiple times in and against the y-direction, that is, perpendicular to the main flow direction, which in the present case runs in the x-direction. Such a wave-shaped gas guide path can be provided by designing the gas guiding structure 37 with sheets selected in the x direction or extending in a zigzag shape and through which the coolant can flow. This gas guiding structure 37 thus provides a partial channel 39 which is delimited by corresponding channel walls 39a provided by the gas guiding structure 37, through which the coolant flows when a cell 16 outgasses. Numerous such partial channels 39 can be provided next to one another, for example in the y-direction or also next to one another in the z-direction. The Z direction can be aligned parallel to a vehicle vertical axis if the cell degassing arrangement 10 is arranged as intended in a motor vehicle. Due to the multiple deflection of the gas flow 20, many of the particles 32 can advantageously be deposited within this partial channel 39 using such a gas guiding structure 37. Furthermore, the multiple deflection results in a braking of the gas 20, which in turn leads to a cooling of the gas. It is particularly advantageous that this gas guiding structure 37 is also designed as a gas cooling or as a component 35 for gas cooling and is accordingly flowed through by a coolant, at the latest when gas 20 emerges from a cell 16 and is discharged to the outlet 28 via the cell degassing channel 12. The gas 20 must necessarily flow through the gas guiding structure 37 and thus flows also through the liquid-cooled component 35, where the gas can give off additional heat. The coolant within this component 35 or these components 35 is circulated by means of a coolant pump 41. The component 35 providing the gas guiding structure 37 and the pump 41 are accordingly part of a cooling circuit 43 through which the coolant flows when the pump 41 is active. However, this cooling circuit 43 can have a significantly more complex structure, although this is not illustrated here. For example, this cooling circuit 43 shown here can only represent a partial circuit of a larger circuit system to which further cooling devices, for example also for cooling the battery 14, are connected. The individual partial circuits can, for example, be designed to be separable from one another and passed through individually by means of valve devices. However, it can also be provided that a separate cooling circuit 43 is provided for cooling the component 35 independently of other cooling circuits. However, it is preferred that this circuit 43 is also coupled or can be coupled to other partial circuits. This has the advantage that the heat given off by the gas flow 20 can be transferred to other components of the motor vehicle. This allows the heat released to be removed from the battery system. This means that very efficient cooling can be provided even if the coolant itself is not cooled by an active measure. In other words, the component 35, through which the coolant flows can provide only semi-active cooling by means of the active pump 41, although no active cooling of the coolant itself is provided. This circulation of the cooling water within the partial circuit or partial battery circuit or overall vehicle cooling circuit already enables heat to be removed and distributed while utilizing the thermal capacity of other battery components and vehicle components. This allows extremely efficient cooling of the gas flow 20, so that the ultimately emerging gas flow 20′ is significantly cooled and also has significantly fewer particles 22. In this way, spontaneous ignition of the escaping gas 20′ can ultimately be advantageously ruled out. This can significantly increase the safety of gas discharging.

In principle, it is also conceivable, for example, to implement such semi-active or active cooling in a component of the cell degassing channel 12 that is different from this gas guiding structure 37, for example in the chamber wall 24a or generally in the cell degassing channel wall 12a. These channel walls 12a, 24a can thus also be designed, for example, in such a way that a coolant can flow through them, at least as soon as a cell 16 outgasses and a gas flow 20 is correspondingly discharged through the cell degassing channel 12.

In addition, the component 35 for gas cooling can take on many other forms, as will be explained in more detail below.

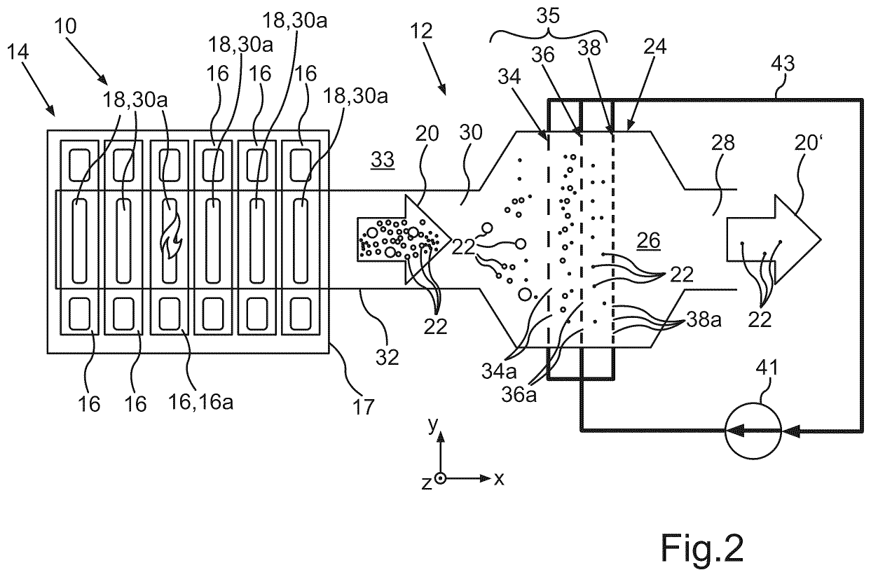

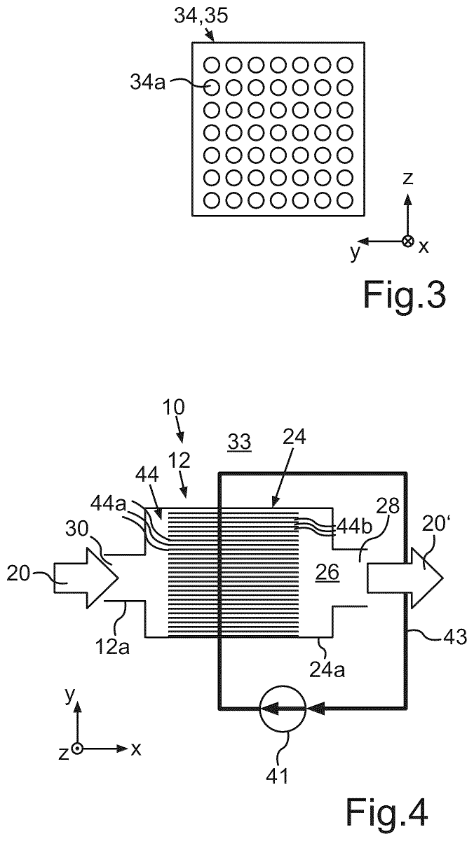

For this purpose, FIG. 2 shows, for example, a further example of a cell degassing channel arrangement 10, which can be designed in exactly the same way as described in FIG. 1, except for the differences described below. In this example, the component 35 through which the coolant can flow is designed somewhat differently. In particular, this is provided by a plurality of perforated plates 34, 36, 38 arranged in the interior 26 of the cell degassing channel 12. A first perforated plate 34 of these perforated plates 34, 36, 38 is shown again in a top view as an example in FIG. 3. A respective perforated plate has multiple holes 34a, 36a, 38a. In the main flow direction, which in turn corresponds to the x direction, the holes 34a, 36a, 38a become smaller passing from perforated plate to perforated plate. As a result, successive filtering of the particles 22 contained in the gas flow 20 can be provided. In addition, the gas 20 also impinges on the regions between the holes 34a, 36a, 38a of the perforated plates 34, 36, 38 and can thereby be decelerated and cooled particularly efficiently by the coolant flowing through these perforated plates 34, 36, 38. The cooling can be implemented as previously described, for example as semi-active cooling, according to which the coolant is simply pumped through the coolant circuit 43 by a coolant pump 41, for example without the coolant being additionally cooled. It is still possible to cool the coolant, for example by activating a radiator fan. This, in turn, can be advantageous in achieving that the gas 20′ that eventually emerges from the outlet 28 has cooled down significantly and contains considerably fewer particles 22.

FIG. 4 shows a further example of a cell degassing channel arrangement 10. This can also be designed as described above, in particular, for example, as described in FIG. 1, except for the differences described below. In this example, the battery 14 is also not shown. However, this can be connected to the cell degassing channel 12 in the same way as described above. In this example, the component 35 through which the coolant can flow is now designed in the form of a finned cooling 44. This fin cooling 44 can be designed similarly to a water cooler with a fin structure, as is often found in the region of a radiator grille of a motor vehicle. Numerous small flow channels 44b are formed by the fins 44a, only some of which are provided with a reference number for reasons of clarity. For example, the fins 44a can be designed so that the coolant can flow through them or can be arranged on one or more cooling plates through which the coolant can flow. In particular, these fins 44a can also divide the space between such cooling plates, through which the coolant flows, into individual channels 44b. Such a fin cooling 44 can provide an extremely large cooling surface. The gas 20, which flows through this finned cooling system 44, can be cooled very strongly and in turn leaves the outlet opening 28 as cooled down gas 20′.

Further configurations of the component 35 for gas cooling are also conceivable. For example, the operating principle of a typical EGR (exhaust gas recirculation) cooler can also be used for this purpose. However, it is particularly advantageous that the simultaneous design of such a component 35 for gas cooling as a gas guiding structure, which additionally influences the gas guidance of the gas flow 20 flowing through the cell degassing channel 12, provides the possibility of using other effects in addition to gas cooling, such as braking, redirecting and, above all, particle separation. The structure through which the harmful gas 20 flows can therefore be designed differently, as described, in order to also separate particles 22 and reduce the flow velocity.

Overall, the examples show how the invention can provide a harmful gas cooler for battery systems, which makes it possible to cool harmful gas in a particularly efficient manner so that it is supplied to the environment with little or no particles after it emerges from the outlet opening and can no longer self-ignite due to its low temperature. It is therefore possible to reduce the exit temperature of the harmful gas and the particles contained therein to such an extent that the escape of a flame from the battery system or spontaneous ignition of the gas outside the battery can be ruled out. This advantageously enables the thermal energy of the harmful gas produced in a cell during thermal runaway to be dissipated by utilizing the thermal capacity of the partial (battery) or vehicle cooling circuit.

1-10. (canceled)

11. A cell degassing channel arrangement with a cell degassing channel for discharging gases from a battery which has at least one battery cell, wherein the cell degassing channel
has at least one at least releasable inlet opening;
has at least one at least releasable outlet opening; and
is designed in such a way that a gas exiting from the at least one battery cell can be introduced into the cell degassing channel through the at least one inlet opening, can be guided through the channel to the at least one outlet opening and can be discharged from the at least one outlet opening;
wherein the cell degassing channel has at least one component for gas cooling that is different from a cooling device for cooling the battery and through which a coolant can flow, which component is arranged in such a way that, in the event that a gas exiting the at least one battery cell is introduced into the cell degassing channel, the component is at least partially flowed over by the gas, when the gas is flowing through the cell degassing channel.

12. The cell degassing channel arrangement according to claim 11, wherein the cell degassing channel arrangement is designed such that the coolant flows through the component when a gas flows through the cell degassing channel.

13. The cell degassing channel arrangement according to claim 11, wherein the cell degassing channel arrangement has a pumping device which is designed to pump a coolant through the component, and a control device for controlling the pumping device, wherein the cell degassing channel arrangement is designed such that the control device activates the pumping device at the latest when a fault detection signal is received from the control device, which signal relates to a gas escape of a gas from the at least one battery cell.

14. The cell degassing channel arrangement according to claim 11, wherein the cell degassing channel arrangement is designed such that the coolant flowing through the component is not actively cooled.

15. The cell degassing channel arrangement according claim 11, wherein the cell degassing channel arrangement is designed such that the coolant flowing through the component is actively cooled.

16. The cell degassing channel arrangement according to claim 11, wherein the cell degassing channel has a channel wall which separates an interior of the cell degassing channel from an environment, wherein, in the interior of the cell degassing channel, a gas guiding structure is arranged which is different from the channel wall and which is designed to influence the flow behavior of a gas flow flowing through the cell degassing channel, wherein the gas guiding structure comprises or represents the component for gas cooling.

17. The cell degassing channel arrangement according to claim 11, wherein the gas guiding structure has numerous fins, which preferably divide the interior of the cell degassing channel at least in some regions into numerous individual flow channels, wherein each of the flow channels adjoins a channel wall provided by the component, which delimits the respective flow channel, and/or wherein the fins are arranged on the component.

18. The cell degassing channel arrangement according to claim 11, wherein the gas guiding structure does not extend in a straight line in a main direction, which corresponds to a first direction, and is designed in such a way that a gas flow flowing through the cell degassing channel undergoes multiple changes of direction by the gas guiding structure in its course in the main direction, with respect to a second direction perpendicular to the first; and/or is designed as at least one perforated plate arranged in the interior at an angle to the main direction, which plate has multiple holes which can at least partially be flown through by a gas flow flowing in the cell degassing channel.

19. The cell degassing channel arrangement according to claim 11, wherein the cell degassing channel arrangement comprises the battery with the at least one battery cell.

20. A method for discharging gases from a battery, which has at least one battery cell, via a cell degassing channel, which has at least one at least releasable inlet opening; and
has at least one at least releasable outlet opening;
wherein a gas exiting from the at least one battery cell is introduced at least in part through the at least one inlet opening into the cell degassing channel, through which it is guided to the at least one outlet opening, and which is discharged from the at least one outlet opening,
wherein the cell degassing channel has at least one component for gas cooling that is different from a cooling device for cooling the battery and through which a coolant can flow, which component, in the event that a gas exiting the at least one battery cell is introduced into the cell degassing channel, is flowed through by coolant and is at least partially flown over by the gas, while it is flowing through the cell degassing channel.

21. The cell degassing channel arrangement according to claim 12, wherein the cell degassing channel arrangement has a pumping device which is designed to pump a coolant through the component, and a control device for controlling the pumping device, wherein the cell degassing channel arrangement is designed such that the control device activates the pumping device at the latest when a fault detection signal is received from the control device, which signal relates to a gas escape of a gas from the at least one battery cell.

22. The cell degassing channel arrangement according to claim 12, wherein the cell degassing channel arrangement is designed such that the coolant flowing through the component is not actively cooled.

23. The cell degassing channel arrangement according to claim 13, wherein the cell degassing channel arrangement is designed such that the coolant flowing through the component is not actively cooled.

24. The cell degassing channel arrangement according claim 12, wherein the cell degassing channel arrangement is designed such that the coolant flowing through the component is actively cooled.

25. The cell degassing channel arrangement according claim 13, wherein the cell degassing channel arrangement is designed such that the coolant flowing through the component is actively cooled.

26. The cell degassing channel arrangement according to claim 12, wherein the cell degassing channel has a channel wall which separates an interior of the cell degassing channel from an environment, wherein, in the interior of the cell degassing channel, a gas guiding structure is arranged which is different from the channel wall and which is designed to influence the flow behavior of a gas flow flowing through the cell degassing channel, wherein the gas guiding structure comprises or represents the component for gas cooling.

27. The cell degassing channel arrangement according to claim 13, wherein the cell degassing channel has a channel wall which separates an interior of the cell degassing channel from an environment, wherein, in the interior of the cell degassing channel, a gas guiding structure is arranged which is different from the channel wall and which is designed to influence the flow behavior of a gas flow flowing through the cell degassing channel, wherein the gas guiding structure comprises or represents the component for gas cooling.

28. The cell degassing channel arrangement according to claim 14, wherein the cell degassing channel has a channel wall which separates an interior of the cell degassing channel from an environment, wherein, in the interior of the cell degassing channel, a gas guiding structure is arranged which is different from the channel wall and which is designed to influence the flow behavior of a gas flow flowing through the cell degassing channel, wherein the gas guiding structure comprises or represents the component for gas cooling.

29. The cell degassing channel arrangement according to claim 15, wherein the cell degassing channel has a channel wall which separates an interior of the cell degassing channel from an environment, wherein, in the interior of the cell degassing channel, a gas guiding structure is arranged which is different from the channel wall and which is designed to influence the flow behavior of a gas flow flowing through the cell degassing channel, wherein the gas guiding structure comprises or represents the component for gas cooling.

30. The cell degassing channel arrangement according to claim 12, wherein the gas guiding structure has numerous fins, which preferably divide the interior of the cell degassing channel at least in some regions into numerous individual flow channels, wherein each of the flow channels adjoins a channel wall provided by the component, which delimits the respective flow channel, and/or wherein the fins are arranged on the component.
